(19) United States
(12) Patent Application Publication
(10) Pub. No.: US 2016/0021698 A1
(43) Pub. Date: Jan. 21, 2016

(54) DYNAMIC DATA PATH SWITCHING

(71) Applicant: QUALCOMM Incorporated, San Diego, CA (US)

(72) Inventors: Suli ZHAO, San Diego, CA (US); Sivaramakrishna VEEREPALLI, San Diego, CA (US); Ajith Tom PAYYAPPILLY, San Diego, CA (US); Uppinder Singh BABBAR, San Diego, CA (US); Gerardo GIARETTA, La Jolla, CA (US)

(21) Appl. No.: 14/335,524

(22) Filed: Jul. 18, 2014

(51) Int. Cl. H04W 76/04; H04L 12/46

(52) U.S. Cl. CPC H04W 76/04; H04L 12/4633

(57) ABSTRACT

Certain aspects of the present disclosure relate to switching data paths in a wireless device having first and second processors. The wireless device may determine a change to a service, the service using a first data path including a first internet protocol (IP) stack on the first processor and lower layer processing on a wireless modem, the first data path providing a tunneled connection to the service through a network. The wireless device may establish a second data path for the service, the second data path including a second IP stack on the second processor including tunneling to the service through the network and the lower layer processing on the wireless modem. The wireless device may switch the service from the first data path to the second data path in response to establishing the second data path. The first processor may be placed in a power save mode.

### BACKGROUND

Aspects of the present disclosure relate generally to wireless communications, and more particularly, to data path processing for wireless communications.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

A UE may also communicate with a wireless communication network via one or more alternative access networks such as, for example, a wireless local area network (WLAN), 1× network, or a high rate packet data (HRPD) network. The UE may include interworking to allow access to network services via the alternative access network. The UE may also include multiple processors that may be specialized for providing particular network services or establishing connections with particular access networks. As a network services changes after instantiation, the UE may perform processing for the network service on multiple processors. The data path for the network service may be inefficient. For example, the UE may be unable to use a power save mode for any processor that is providing the network service. In view of the foregoing, it may be desirable to employ a more efficient data path for processing a network service.

### SUMMARY OF THE DISCLOSURE

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects of the present disclosure relate to switching data paths in a wireless device having a first processor and a second processor. The wireless device may determine a change to a service, the service using a first data path including a first internet protocol (IP) stack on the first processor and lower layer processing on a wireless modem, the first data path providing a tunneled connection to the service through a network. The wireless device may establish a second data path for the service, the second data path including a second IP stack on the second processor including tunneling to the service through the network and the lower layer processing on the wireless modem. The wireless device may switch the service from the first data path to the second data path in response to establishing the second data path. The first processor may be placed in a power save mode.

In accordance with an aspect, a method for switching data paths in a wireless device having a first processor and a second processor may include determining a change to a service, the service using a first data path including a first IP stack on the first processor and lower layer processing on a wireless modem, the first data path providing a tunneled connection to the service through a network. The method may further include establishing a second data path for the service, the second data path including a second IP stack on the second processor including tunneling to the service through the network and the lower layer processing on the wireless modem; and switching the service from the first data path to the second data path in response to establishing the second data path.

In accordance with another aspect, the disclosure provides an apparatus for switching data paths of a service. The apparatus may include first means for processing; second means for processing; means for determining a change to a service, the service using a first data path including a first IP stack on the means for processing and lower layer processing on a wireless modem, the first data path providing a tunneled connection to the service through a network; means for establishing a second data path for the service, the second data path including a second IP stack on the second means for processing including tunneling to the service through the network and the lower layer processing on the wireless modem; and means for switching the service from the first data path to the second data path in response to establishing the second data path.

Another aspect of the disclosure provides a computer-readable medium storing computer executable code. The computer-readable medium may include: code for causing a computer to determine a change to a service, the service using a first data path including a first IP stack on the first processor and lower layer processing on a wireless modem, the first data path providing a tunneled connection to the service through a network; code for causing a computer to establish a second data path for the service, the second data path including a second IP stack on the second processor including tunneling to the service through the network and the lower layer processing on the wireless modem; and code for causing a computer to switch the service from the first data path to the second data path in response to establishing the second data path.

In another aspect, the disclosure provides a wireless communication device for switching data paths of a service. The wireless communication device may include: a first processor; a second processor; a wireless modem connected to the first processor and the second processor; a service component configured to determine a change to a service, the service using a first data path including a first IP stack on the first processor and lower layer processing on the wireless modem, the first data path providing a connection to the service through a network; a tunneling component configured to establish a second data path for the service, the second data path including a second IP stack on the second processor including tunneling to the service through the network and the lower layer processing on the wireless modem; and a switching component configured to switch the service from the first data path to the second data path in response to establishing the second data path.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a telecommunications system in accordance with an aspect of the present disclosure.

FIG. 2 is a flow diagram conceptually illustrating a method for switching data paths for a service in accordance with an aspect of the present disclosure.

FIG. 3A is a block diagram conceptually illustrating scenario where a service is processed on a data path on a modem processor in accordance with an aspect of the present disclosure.

FIG. 3B is a block diagram conceptually illustrating a scenario where a service is processed by a data path on an application processor and a modem processor in accordance with an aspect of the present disclosure.

FIG. 3C is a block diagram conceptually illustrating a scenario where a service is processed by a data path on an application processor in accordance with an aspect of the present disclosure.

FIG. 4A is a timing diagram conceptually illustrating an example of a rekeying procedure in accordance with an aspect of the present disclosure.

FIG. 4B is a timing diagram conceptually illustrating an example of a parallel rekeying procedure in accordance with an aspect of the present disclosure.

FIG. 5 is a block diagram conceptually illustrating an example of a telecommunications system including interfaces in accordance with an aspect of the present disclosure.

FIG. 6 is a diagram conceptually illustrating an example radio protocol architecture in accordance with an aspect of the present disclosure.

FIG. 7 is a block diagram conceptually illustrating an exemplary eNodeB and an exemplary UE configured in accordance with an aspect of the present disclosure.

FIG. 8 illustrates a block diagram conceptually illustrating an aggregation of LTE and WLAN radio access technologies at a user equipment (UE), in accordance with an aspect of the present disclosure.

FIG. 9 is a block diagram illustrating an example of a hardware implementation for an apparatus employing a processing system in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

A user equipment (UE) may be configured to access a network service of a 3GPP network via an alternative access network. A service may be a distinct part of a functionality that is provided by an entity on one side of an interface to an entity on the other side of the interface. For example, a service may include a network service provided by a network to a UE. In an aspect, an application on the UE may be considered a service or may use one or more services. The UE may establish an authenticated connection to the 3GPP network using a tunneling protocol. The network service may initially be processed by one of multiple processors of the UE. For example, a voice call may initially be processed by a modem processor. As another example, a video call may initially be processed by an application processor. The processor handling the initial processing may also perform IP stack processing for the network service including the necessary tunneling. In an aspect, the network service may change such that the processor responsible for the network service changes. For example, a voice call being processed by the modem processor may be changed to a video call, or to a call including some video features or component, which may need to be processed by the application processor. Such a change may result in a data path in which the network service is processed by the application processor, but the IP stack processing including tunneling remains with the modem processor. A similar situation may occur when a network service is switched from an application processor to a modem processor. It may be desirable to dynamically switch the data path for the network service such that only a single processor is used. When a single processor is used to handle the network service, the other processor may then be placed into a power save mode.

In an aspect, the present disclosure provides for dynamic data path switching. A UE may be configured to determine a change to the network service. The UE may establish a second data path for the network service including tunneling performed by a second processor. The UE may acquire a new tunneling parameter to install on the second processor while the tunneling is maintained on the first processor. A tunneling parameter may include any parameter configured for a tunneled connection. For example, a tunneling parameter may include an IPsec security association (SA), a key, an address, an identifier, or a setting. Once the new tunneling parameter is installed, the network service may be dynamically switched to the second data path without data loss.

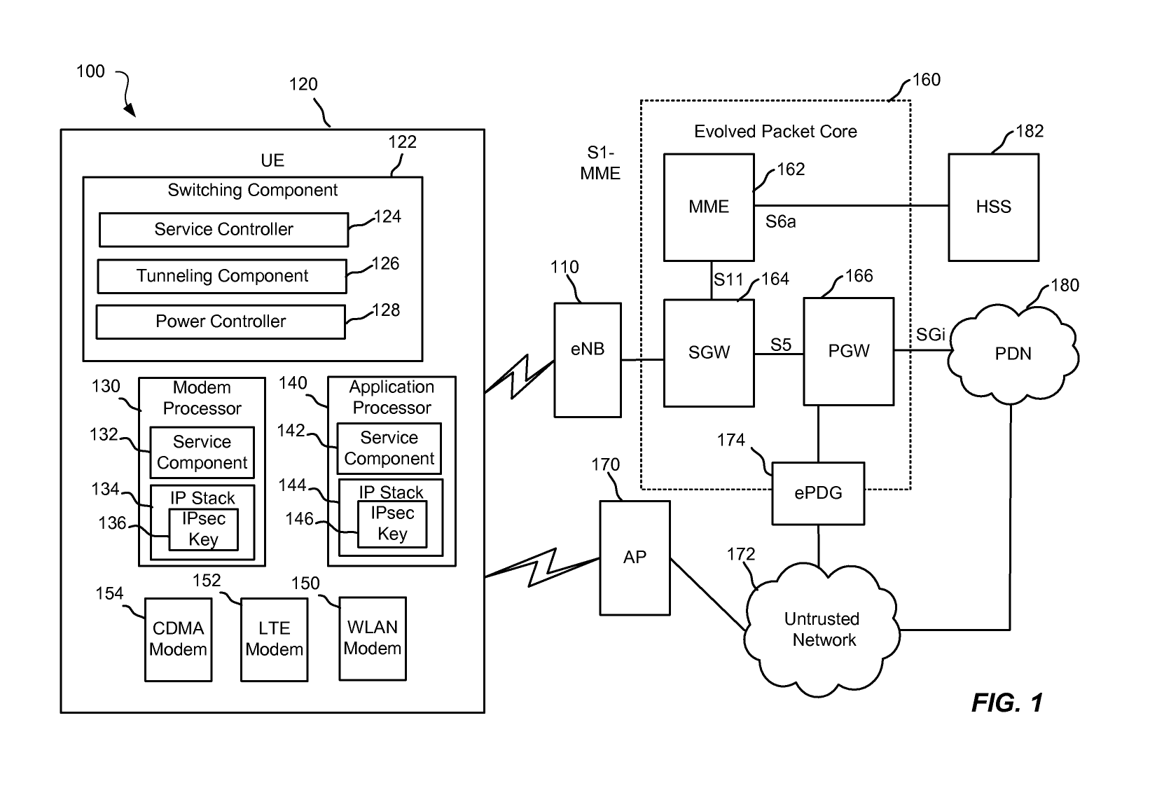

FIG. 1 is a block diagram conceptually illustrating an example of a telecommunications network system 100 in accordance with an aspect of the present disclosure. For example, the telecommunications network system 100 may include a wireless wide area network (WWAN), such as an LTE network, for example. The telecommunications network system 100 may include a number of evolved NodeBs (eNodeBs) 110 and user equipment (UEs) 120 and other network entities. An eNodeB 110 may be a station that communicates with the UEs 120 and may also be referred to as a base station, an access point, etc. A NodeB is another example of a station that communicates with the UEs 120. Each eNodeB 110 may provide communication coverage for a particular geographic area. In 3GPP, the term “cell” can refer to a coverage area of an eNodeB 110 and/or an eNodeB subsystem serving the coverage area, depending on the context in which the term is used.

In an aspect, the telecommunications network system 100 may include an evolved packet core (EPC) 160, an access point (AP) 170, a PDN 180. The EPC 160 may include a mobility management entity (MME) 132, a serving gateway (SGW) 134, and a packet data network (PDN) gateway (PGW) 136, and an evolved packet data gateway (ePDG) 174. A home subscriber system (HSS) 182 may be communicatively coupled with the MME 162. The system 100 may provide the UE 120 with access to services provided by the EPC 160 as well as services provided by a packet data network 180

The UE 120 may be a multi-mode UE capable of using multiple radio access technologies such as, for example, LTE, WLAN, CDMA, or GSM. The UE 120 may be located within a coverage area of the telecommunications network system 100, and may be stationary or mobile. For example, the UE 120 may be referred to as a terminal, a mobile station, a subscriber unit, a station, etc. In another example, the UE 120 may be a cellular phone, a personal digital assistant (PDA), a wireless modem, a wireless communication device, a handheld device, a laptop computer, a cordless phone, a wireless local loop (WLL) station, a tablet, a netbook, a smart book, etc. The UE 120 may include a switching component 122, one or more processors such as a modem processor 130 and an application processor 140, and multiple modems such as a WLAN modem 150, an LTE modem 152, and a CDMA modem 154.

The switching component 122 may be configured to provide dynamic path switching for the UE 120. The switching component 122 may allow the UE 120 to switch a processing data path for an application or service. The switching component 122 may switch processing from a first data path to a second data path. The switching component 122 may include hardware, firmware, and/or software configured to provide dynamic path switching for the UE 120. For example, the switching component 122 may include a software component executed by one or both of the modem processor 130 and the application processor 140. The switching component 122 may include sub-components such as, for example, a service controller 124, a tunneling component 126, and a power controller 128. In an aspect, the term “component” as used herein may be one of the parts that make up a system, may be hardware or software, and may be divided into other components.

The service controller 124 may be configured to determine a change to a service or application (e.g., network service). In an aspect, a service may initially be executed by a first processor. As an example, a voice over IP (VoIP) call may initially be executed by the modem processor 130. The service controller 124 may determine that the service has changed in a manner that requires different processing resources than those being currently used. For example, the VoIP call may be converted into a video telephony call if a user decides to change the type of call being performed (e.g., change the service) by adding video to the call. In the UE 120, video telephony may be handled (e.g., processed) by the application processor 140. The service controller 124 may detect changes to a service or application and request new resources for the service or application. The service controller 124 may also detect a transfer of a service from a first processor to a second processor. For example, the service controller 124 may request that the application processor 140 be used to handle processing of the video telephony call instead of the modem processor 130. The service controller 124 may also release resources after a change.

The tunneling component 126 may be configured to establish tunneling on a data path. For example, the tunneling component 126 may initially establish tunneling on a first data path on a first processor. The first data path may include, for example, service component 132 and IP stack 134 of modem processor 130. The tunneling component 126 may also establish tunneling on a second data path. The second data path may include, for example, the service component 142 and the IP stack 144. When a service switches from the first processor to a second processor, the tunneling component 126 may establish tunneling on the second data path when the service switches processors. The UE 120 may use tunneling when communicating with the EPC 160 through any access network other than an access network controlled by the EPC 160. For example, the EPC 160 may control a 3GPP network, but allow access to services through the ePDG 174 and other access networks. Other access networks may include non-3GPP trusted networks, untrusted networks, or any access network providing access to PDN 180. Tunneling may be used to establish a secure connection between the UE 120 and the EPC 160. For example, tunneling protocols may include Internet Protocol Security (IPsec), Generic Routing Encapsulation (GRE), Versatile Medium Access Control (VMAC), Dual Stack Mobile IP (DSMIP), or any other tunneling protocol. The tunneling component 126 may control acquisition of tunneling parameters and installation of the tunneling parameters on a processor (e.g., modem processor 130, application processor 140). For example, using IPsec, the tunneling component 126 may request an IPsec security association (SA) including an IPsec key from the ePDG 174 using a rekeying procedure. The IPsec key may be installed on either modem processor 130 or application processor 140. The tunneling component 126 may ensure that the tunneling parameters are installed on a target processor of the data path switch (e.g. the second processor) before releasing any previous tunneling parameters from the source or initial processor (e.g. the first processor).

The power controller 128 may be configured to place a processor (e.g., modem processor 130, application processor 140) in a power save mode. A power save mode may also be referred to as a standby or sleep mode, for example. The power controller 128 may include hardware, firmware, and/or software executing on a processor configured to control the power of a processor. The power controller 128 may place the processor in a power save mode when the processor is not processing a service. For example, a processor may be placed in a power save mode after switching the processing of data associated with a service from the processor to a different processor. The power controller 128 may also wake the processor up to an active mode from a power save mode.

The modem processor 130 may include a processor that may be configured to perform processing of a protocol stack for a radio access technology. For example, the modem processor 130 may perform higher layer operations for managing access to EPC 160. The modem processor 130 may also provide certain common services such as call management and wireless messaging services. The modem processor may also provide some IP multimedia services such as native radio coupled services including voice over LTE (VoLTE) and simple messaging service (SMS).

The modem processor 130 may also include a service component 132 and an IP stack 134 including an IPsec key 136. The service component 132 may be configured to perform processing for a service or application. The service component 132 may include firmware or software for processing the service or application. In an aspect, the service component 132 may include a hardware accelerator associated with the service or application. The IP stack 134 may be configured to perform processing for IP and related protocols. For example, the IP stack 134 may place service data into IP packets. The IP stack 134 may also receive IP packets and extract service data from the received IP packets. The IP stack may be configured with one or more tunneling parameters such as IPsec key 134. The tunneling parameters may be used to provide a tunneled connection between the modem processor and the EPC 160. The IP stack 134 may be configured with the IPsec key 134 whenever tunneling is required by a network data path.

The application processor 140 may include a processor that may be configured to execute an operating system for the UE 120. The operating system may be a high level operating system (HLOS). The application processor 140 may also execute any applications running on the operating system. In an aspect, the application processor may process non-native data rich services such as, for example, rich communications suite (RCS) and other data-centric IMS services. The application processor 140 may also include a service component 142 and an IP stack 144 including an IPsec key 146. The service component 142 may be similar to the service component 132. The IP stack 144 may be similar to the IP stack 134 described above with respect to the modem processor 130.

The WLAN modem 150 may be configured to perform lower layer processing for a WLAN radio access technology. In particular, the WLAN modem 150 may perform lower layer processing using a WLAN protocol such as, for example, protocols described in connection with the IEEE 802.11 (Wi-Fi) family of standards. For example, the WLAN modem 150 may perform medium access control and physical layer processing on IP packets for wireless transmission to the access point 170. In an aspect, the access point 170 may provide access through an untrusted network 172. Tunneling may be used when WLAN modem 150 performs lower layer processing.

The LTE modem 152 may be configured to perform lower layer processing for an LTE radio access technology. For example, the LTE modem 152 may perform medium access control and physical layer processing on IP packets for wireless transmission to the eNodeB 110. In an aspect, when using the LTE modem 152 to access EPC 160 through eNodeB 110, the access network may be trusted and tunneling may not be required.

The CDMA modem 154 may be configured to perform lower layer processing for a CDMA radio access technology. For example, the CDMA modem 154 may perform medium access control and physical layer processing on IP packets for wireless transmission to a base station (not shown). The CDMA modem 154 may provide access to a non-3GPP network such as a 1× or high rate packet data (HRPD) network. Tunneling may be used when CDMA modem 154 performs lower layer processing.

The MME 162 may be the control node that processes the signaling between the UE 120 and the EPC 160. Generally, the MME 162 may provide bearer and connection management. The MME 162 may, therefore, be responsible for idle mode UE tracking and paging, bearer activation and deactivation, and SGW selection for the UE 120. The MME 162 may communicate with the eNodeB 110 over an S1-MME interface. The MME 162 may additionally authenticate the UE 120 and implement Non-Access Stratum (NAS) signaling with the UE 120.

The HSS 182 may, among other functions, store subscriber data, manage roaming restrictions, manage accessible access point names (APNs) for a subscriber, and associate subscribers with MMEs 162. The HSS 182 may communicate with the MME 162 over an S6a interface defined by the Evolved Packet System (EPS) architecture standardized by the 3GPP organization.

All user IP packets transmitted over LTE may be transferred through eNodeB 110 to the SGW 164, which may be connected to the PDN gateway 166 over an S5 signaling interface and the MME 162 over an S11 signaling interface. The SGW 164 may reside in the user plane and act as a mobility anchor for inter-eNodeB handovers and handovers between different access technologies. The PDN gateway 166 may provide UE IP address allocation as well as other functions.

The PDN gateway 166 may provide connectivity to one or more external packet data networks, such as PDN 180, over an SGi signaling interface. The PDN 180 may include the Internet, an Intranet, an IP Multimedia Subsystem (IMS), a Packet-Switched (PS) Streaming Service (PSS), and/or other types of PDNs. The PDN 180 may provide network services accessible to the UE 120. In an aspect, some network services may be accessible through the EPC 160, but may not be accessible if the PDN 180 is accessed directly through an untrusted network 172.

The AP 170 may be any access point capable of providing the UE 120 with access to network services provided by the EPC 160. For example the UE 120 may connect to the EPC 160 via the AP 170, untrusted network 172, and ePDG 174 using a tunneling protocol. In an aspect, the connection between UE 120 and EPC 160 may also use the PDN 180. In another aspect, the connections between UE 120 and EPC 160 may use a trusted non-3GPP network.

The ePDG 174 may be a network node configured to provide access to services provided by the EPC 160 to alternative access networks. The ePDG 174 may be considered part of the EPC 160, or may be a node outside of the EPC 160. The ePDG 174 may communicate with other network nodes such as a policy and control rules function (PCRF) or a 3GPP authentication, authorization, and accounting server in order to identify, authenticate, and authorize the UE 120 to access the EPC 160 through an alternative access network such as untrusted network 172. The ePDG 174 may serve as a tunneling endpoint for a tunneled connection to UE 120. The ePDG 174 may perform tunneling procedures such as key exchange in order to establish and/or maintain a tunneled connection.

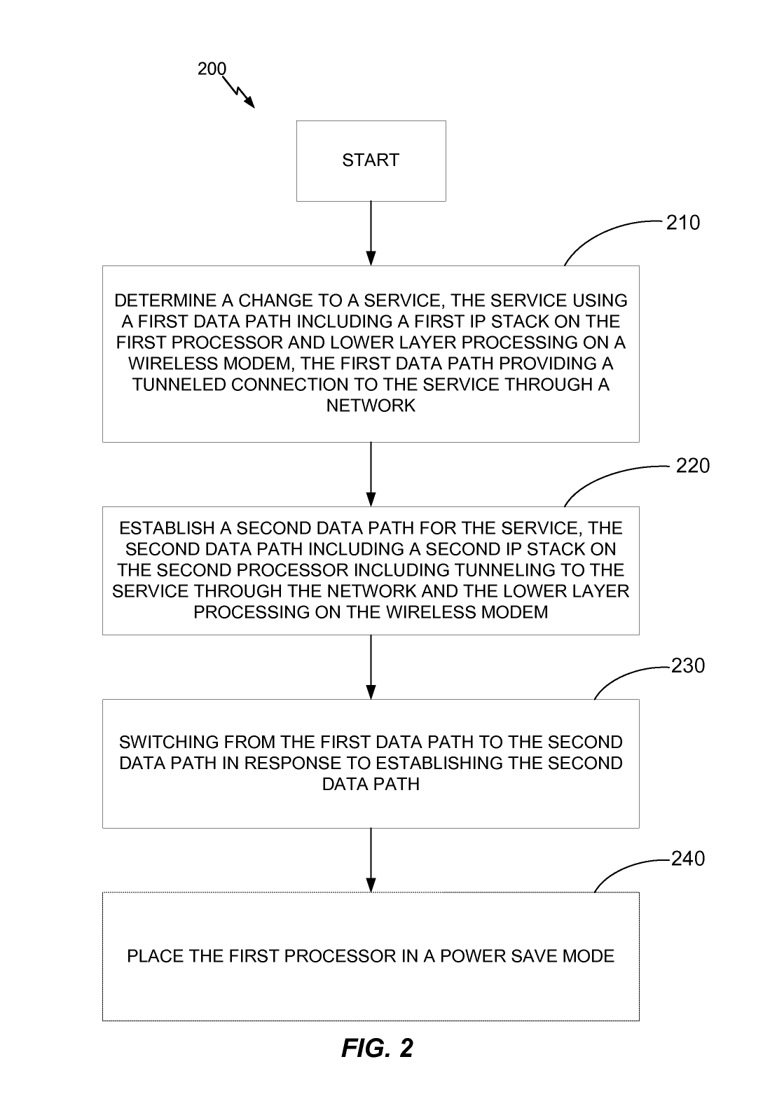

FIG. 2 is a flow diagram illustrating an example method 200 of dynamic data path switching. The method may be performed by a UE (e.g., the UE 120 illustrated in FIG. 1). The UE may include a first processor, a second processor, and a modem.

At block 210, the method 200 may include determining a change to a service, the service using a first data path including an IP stack on the first processor and lower layer processing on a modem, the first data path providing a tunneled connection to the service through a network. For example, the service controller 124 (FIG. 1) may determine the change to the service. The service controller 124 may determine that the service may no longer use the first data path including the IP stack on the first processor and lower layer processing on the modem to provide the tunneled connection to the service. For example, the service controller 124 may determine that the service requires processing performed by the second processor. As an example, the first processor may be the modem processor 130 providing a voice call and the second processor may be the application processor 140. The service controller 124 may determine the change to the service when video is added to the voice call. As another example, the processors may be reversed such that the first processor is the application processor 140 providing video telephony and the second processor is the modem processor 130. The service controller 124 may detect a change to the service when the video is removed from the service and only a voice call remains. The service controller 124 may also detect a change to the service when the service is transferred from the first processor to the second processor.

In block 220, the method 200 may include establishing a second data path for the service, the second data path including a second IP stack on the second processor including tunneling through the network to the service and the lower layer processing on the modem. For example, the tunneling component 126 may establish the second data path for the service, the second data path including a second IP stack on the second processor including tunneling through the network to the service and the lower layer processing on the modem. In an aspect, the tunneling component 126 may obtain a tunneling parameter from the network and install the tunneling parameter on the IP stack of the second processor. In an aspect, the tunneling component 126 may use the modem processor 130 to obtain the tunneling parameter. The tunneling component 126 may release a tunneling parameter for the service on the first data path in response to establishing the second data path.

In block 230, the method 200 may include switching from the first data path to the second data path in response to establishing the second data path. For example, the switching component 122 may switch the service from the first data path to the second data path in response to establishing the second data path. The switching component 122 may cause the second processor to process the service including executing the IP stack using the tunneling parameter. The second processor may send IP packets to a modem (e.g. WLAN modem 150) for lower layer processing.

In block 240, the method 200 may optionally include placing the first processor in a power save mode. For example, the power controller 128 may place the first processor in a power save mode. The power controller 128 may determine that the first processor is no longer processing the service responsive to switching the service from the first data path to the second data path. The power controller 128 may place the first processor in a power save mode in order to reduce power usage and save battery power.

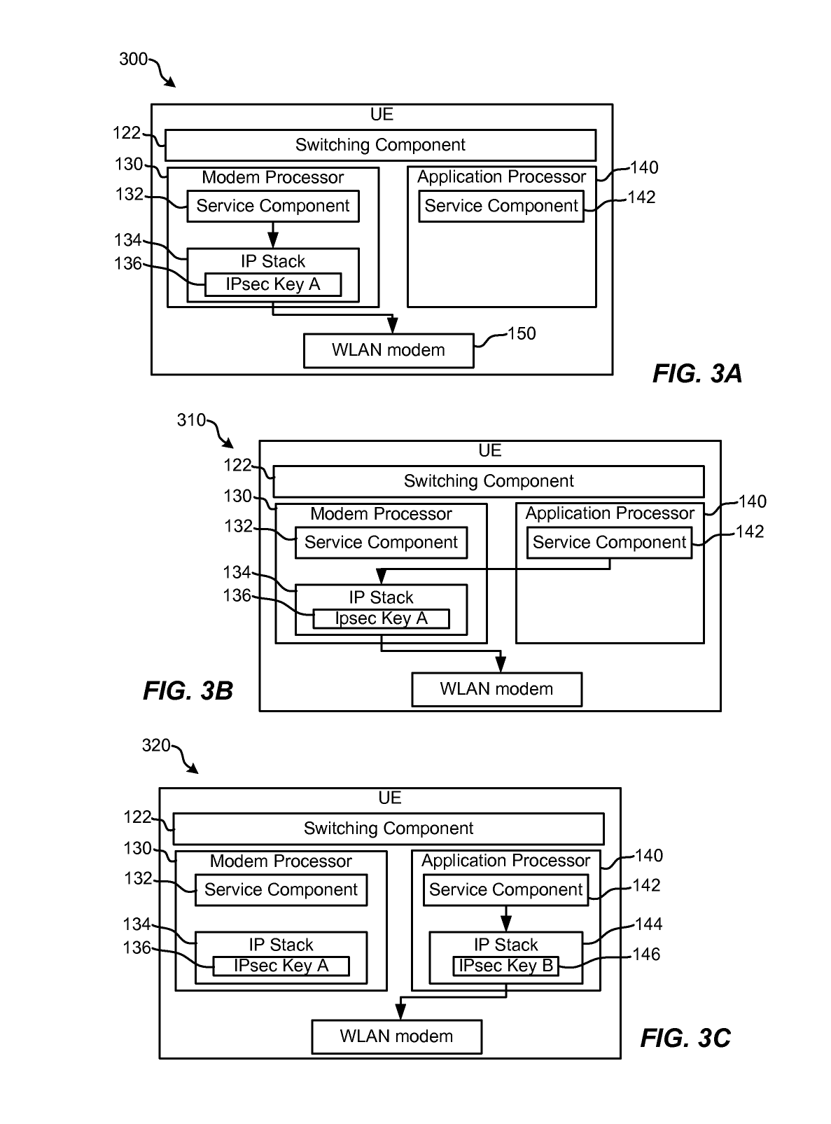

FIGS. 3A-3C illustrate various scenarios having different data paths within a UE 120. Some aspects of the UE 120 may be shown in a simplified block form to highlight key aspects. The UE 120 may use dynamic data path switching to move from the scenario 300 illustrated in FIG. 3A to the scenario 320 illustrated in FIG. 3C. The switching component 122 may transition the UE 120 from scenario 300 directly to scenario 320 by switching the entire data path (i.e. the service component 132 and IP stack 134) to the application processor 140 at approximately the same time using at least the techniques described herein. In another aspect, the scenario 310 of FIG. 3B may be an intermediate step between scenario 300 and scenario 320.

FIG. 3A illustrates a scenario 300 where the modem processor 130 is processing a service. The service component 132 may process instructions and data for the service. The service component 134 may send the data for the service to the IP stack 134. The IP stack 134 including the IPsec key 136 on modem processor 130 may provide network layer processing including IP packetization and tunneling. The IP packets are sent from the IP stack 134 to the WLAN modem 150 for lower layer processing and transmission.

FIG. 3B illustrates a scenario 310 where both the modem processor 130 and the application processor 140 are being used to process the service. As illustrated, for example, the service component 142 of the application processor 140 may process the service, and the IP stack 134 of the modem processor 130 may provide network layer processing including IP packetization and tunneling. That is, the application processor 140 may drive the IP stack 134 on the modem processor. In an aspect, the arrangement of scenario 310 may be inefficient because both processors 130 and 140 are active and cannot be placed in a power save mode. The switching component 122 may avoid scenario 310 by directly switching the UE 120 to scenario 320. In another aspect, the switching component 122 may switch the UE 120 out of scenario 320 to avoid inefficiency.

FIG. 3C illustrates a scenario 320 where the application processor 140 is processing the service. As illustrated, for example, the service component 142 may process the service and the IP stack 144 may perform network layer processing using the tunneling parameter 146. The tunneling parameter 146 may be the same or different from the tunneling parameter 136. For example, as illustrated, the tunneling parameter 136 may be an IPsec key having a value A, whereas the tunneling parameter 146 may be an IPsec key having a value B. The tunneling parameter 146 may be obtained using a rekeying procedure such that the IP stack 144 may be established for the same connection using a different key. The rekeying procedure may allow the tunneled connection to the service to be maintained while switching processors and tunneling parameters. Moreover, as discussed in further detail below, the rekeying procedure may be used to prevent packet loss while switching processors. In another aspect, the tunneling parameter 136 may be copied to the IP stack 146 such that the same tunneling parameter is used.

The switching component 122 may also perform the dynamic data path switching operation in the opposite direction. That is, the switching component 122 may switch the UE 120 from scenario 320 to scenario 300. When switching to scenario 300, the tunneling component 126 of the switching component 122 may establish new tunneling parameters (e.g. an IPsec Key C (not shown)) on the IP stack 134 of the modem processor 130.

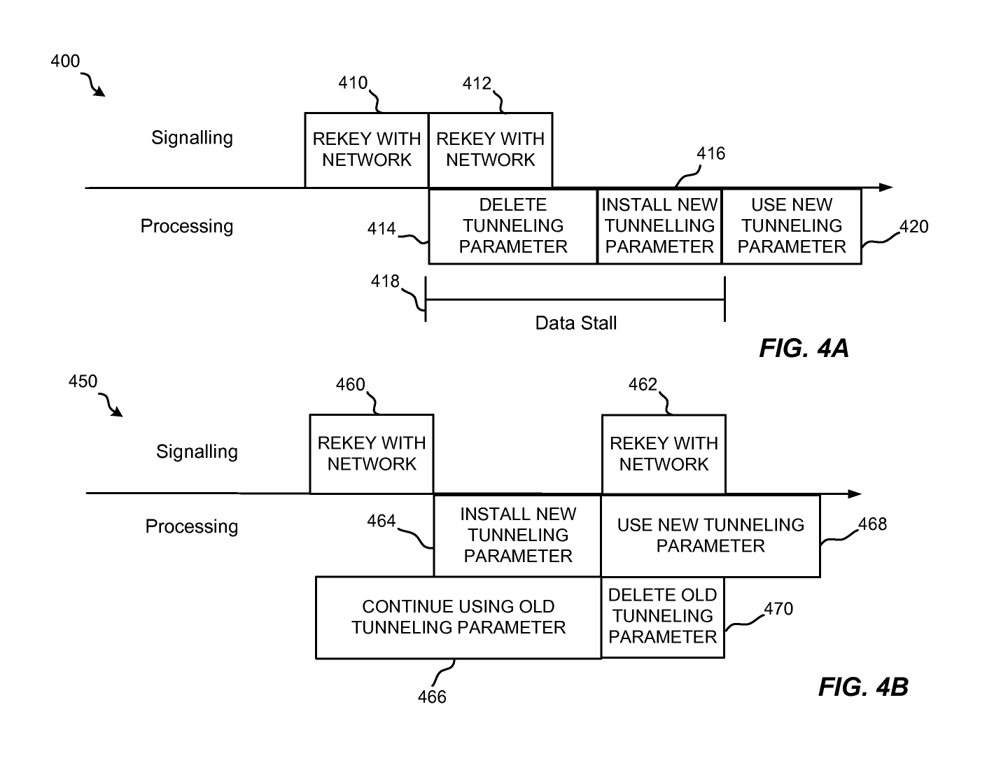

FIGS. 4A and 4B illustrate timing diagrams for performing a rekeying procedure. The rekeying procedure may be used to obtain new tunneling parameters, for example, a new key for tunneling. In an aspect, the tunneling protocol may use multiple parameters, for example, one key in each direction. For simplicity, the rekeying procedures are described with respect to a single key, which may represent any tunneling parameters that are changed. In an aspect, other tunneling parameters, addresses for example, may be copied from one processor to the other without changing. The rekeying procedure may be performed by the tunneling component 126 using at least one of the processors, for example, the modem processor 130 and/or the application processor 140. In an aspect, the modem processor 130 may be configured to perform a key exchange procedure, and may transfer one or more tunneling parameters to the application processor 140 once the parameters are obtained. The key exchange procedure may be defined by the tunneling protocol. For example, IPsec protocol uses the Internet key exchange (IKE) procedure. The rekeying procedure may be used when a processor for a service is switched in either direction, that is, from the modem processor 130 to the application processor 140 or from the application processor 140 to the modem processor 130.

In FIG. 4A, the rekeying procedure 400 may be performed sequentially. In block 410, the tunneling component 126 may initiate rekeying with the ePDG 174. When the new tunneling parameter is obtained, the tunneling component 126 may, in block 412, signal the network to delete the old tunneling parameter (e.g. the old SA). Concurrently, in block 414, the tunneling component 126 may delete the old tunneling parameter. When the old tunneling parameter is deleted, the tunneling component 126 may install the new tunneling parameter, for example, on the second processor. The rekeying procedure 400 may result in a period of data stall 418 when the UE 120 is unable to transmit data because no tunneling parameter is installed. The period of data stall 418 may last from the receipt of the new tunneling parameter until installation of the new tunneling parameter is complete. In block 420, the processor may begin using the new tunneling parameter.

FIG. 4B illustrates a timing diagram for a parallel rekeying procedure 450. The rekeying procedure 450 may also be performed by the tunneling component 126 using the modem processor 130 and the application processor 140. For example, the parallel rekeying procedure 450 may be used to move a data path from the modem processor 130 to the application processor 140. In block 460, the tunneling component 126 may initiate rekeying with the ePDG 174. In block 462, the tunneling component 126 may delay deletion of the old tunneling parameter until the new tunneling parameter is installed on the application processor 140. In block 464, the application processor 140 may install the new tunneling parameter in the IP stack 144. Concurrently, in block 466, the modem processor 130 may continue using the old tunneling parameter 136 to process the service. In block 468, after the new tunneling parameter 146 is installed, the application processor 140 may begin processing the service using the new tunneling parameter. In block 470, concurrently with block 468, the modem processor 130 may delete the old tunneling parameter 136. In an aspect, the connection with the network may be configured to allow additional delay in installing the new tunneling parameter and for continued use of an old tunneling parameter after the new tunneling parameter is provided by the network. In an aspect, a similar rekeying procedure may be used to move a data path from the application processor to the modem processor 130 with the roles of the processors reversed. In an aspect, such a rekeying procedure may be faster because the modem processor may directly obtain the new tunneling parameter from the network.

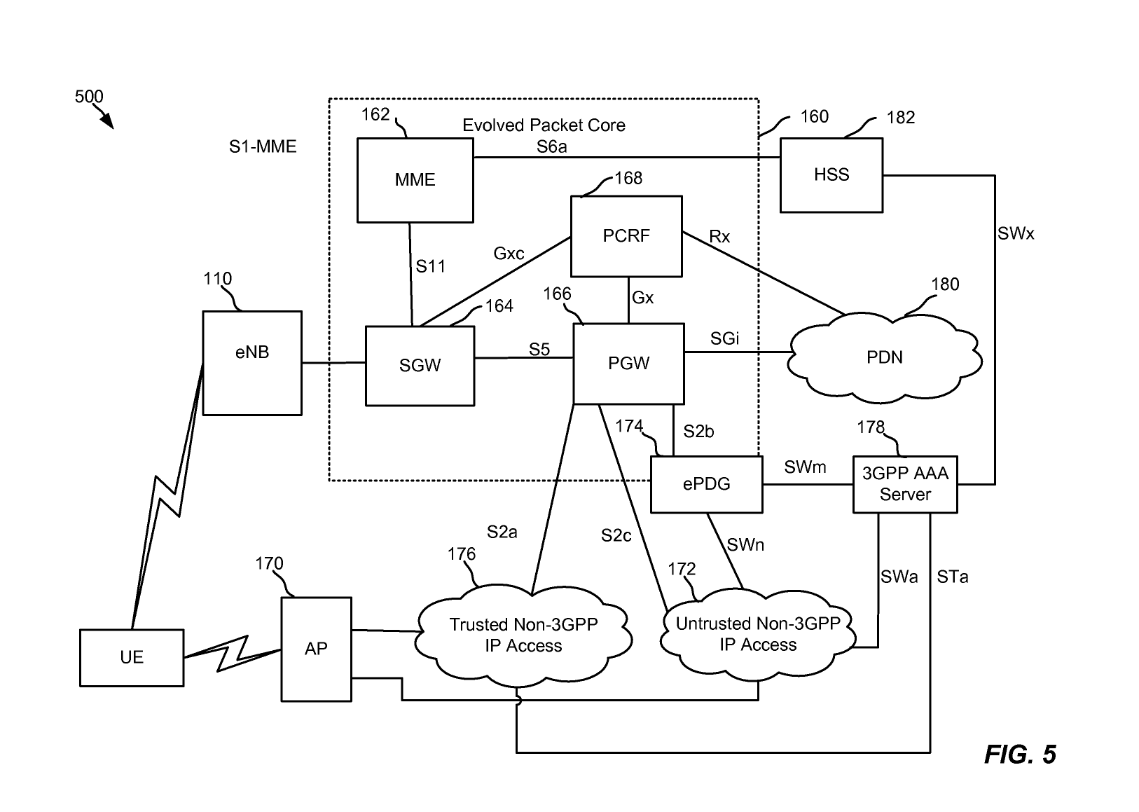

FIG. 5 illustrates an example of a telecommunications network system 500 in accordance with an aspect of the present disclosure. The telecommunications network system 500 may include similar network elements as the telecommunications network system 100 (FIG. 1) where like reference numbers indicate like elements. The telecommunications network system 500 may include: an eNodeB 110, a UE 120, an EPC 160 including MME 162, SGW 164, PGS 166, and a policy and charging rules function (PCRF) 168, an access point 170, an untrusted non-3GPP IP access network 172, an ePDG 174, a trusted non-3GPP IP access network 176, a 3GPP AAA server 178, a packet data network 180 and a HSS 182.

The PCRF 168 may provide policy and charging rules for providing and charging for quality of service (QoS) for network services. The trusted non-3GPP IP access network 176 may be an alternative access network. The network 176 may be trusted by the EPC 160 because it is controlled by the same operator as the EPC 160 or under another agreement. For example, the network 176 may be a 1× network or a HRPD network. The network 176 may be accessed by UE 120 via an AP 170 and/or a base station (not shown). The 3GPP AAA server 178 may provide for authentication, authorization, and accounting (AAA) for access via the alternative access networks 172 and 176.

The trusted non-3GPP IP access network 176 may directly communicate with the PGW 166 via an S2a interface. The untrusted non-3GPP IP access network 172 may communicate with the ePDG 174, which in turn communicates with the PGW 166 via an S2b interface. In another aspect, the untrusted non-3GPP access network 172 may communicate directly with the PGW 166 via an S2c interface. Each of the S2 interfaces may use tunneling.

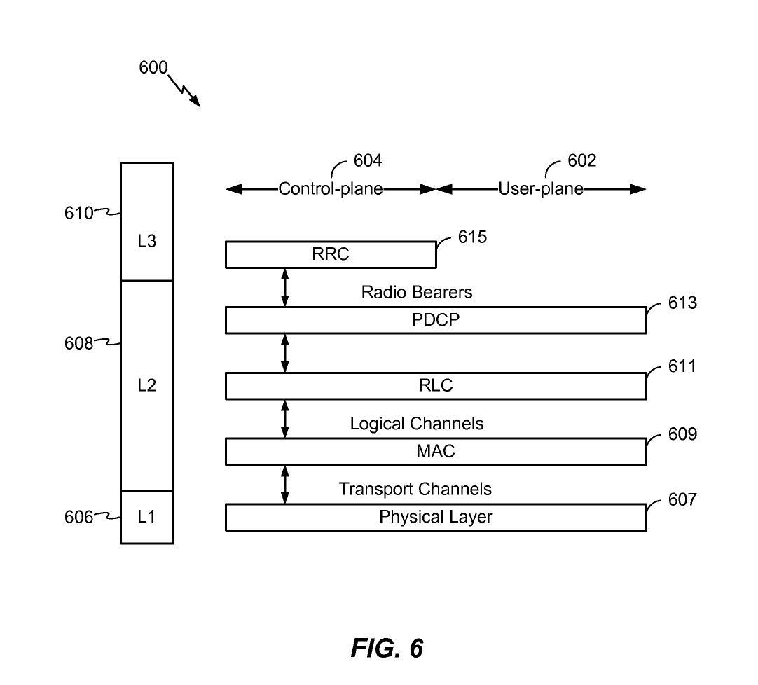

Referring to FIG. 6, an example radio protocol architecture 600 relates to the user plane 602 and the control plane 604 of a UE 120 and a network node such as, for example, eNodeB 110, a base station, or access point 170. For example, architecture 600 may be included in a UE such as UE 120 (FIG. 1) having switching component 122. The radio protocol architecture 600 for the UE and one or more network nodes is shown with three layers: Layer 1 606, Layer 2 608, and Layer 3 610. Layer 1 606 is the lowest lower and implements various physical layer signal processing functions. As such, Layer 1 606 includes the physical layer 607. Layer 2 (L2 layer) 608 is above the physical layer 607 and is responsible for the link between the UE and network node over the physical layer 607. Layer 3 (L3 layer) 610 includes a radio resource control (RRC) sublayer 615. The RRC sublayer 615 handles the control plane signaling of Layer 3 between the UE and the network.

In the user plane, the L2 layer 608 includes a media access control (MAC) sublayer 609, a radio link control (RLC) sublayer 611, and a packet data convergence protocol (PDCP) 613 sublayer, which are terminated at the eNodeB on the network side. Although not shown, the UE may have several upper layers above the L2 layer 608 including a network layer (e.g., IP layer) that is terminated at a PDN gateway on the network side, and an application layer that is terminated at the other end of the connection (e.g., far end UE, server, etc.). In an aspect, one of the IP stacks 134 or 144 may be responsible for the upper layers such as the network layer, and a modem, e.g. WLAN modem 150 (FIG. 1), is responsible for processing at layers L1 and L2. In an aspect where the WLAN modem 150 provides a connection to an access point 170, RLC sublayer 611 and PDCP 613 may not be used.

The PDCP sublayer 613 provides multiplexing between different radio bearers and logical channels. The PDCP sublayer 613 also provides header compression for upper layer data packets to reduce radio transmission overhead, security by ciphering the data packets, and handover support for UEs between eNodeBs. The RLC sublayer 611 provides segmentation and reassembly of upper layer data packets, retransmission of lost data packets, and reordering of data packets to compensate for out-of-order reception due to hybrid automatic repeat request (HARQ). The MAC sublayer 609 provides multiplexing between logical and transport channels. The MAC sublayer 609 is also responsible for allocating the various radio resources (e.g., resource blocks) in one cell among the UEs. The MAC sublayer 609 is also responsible for HARQ operations.

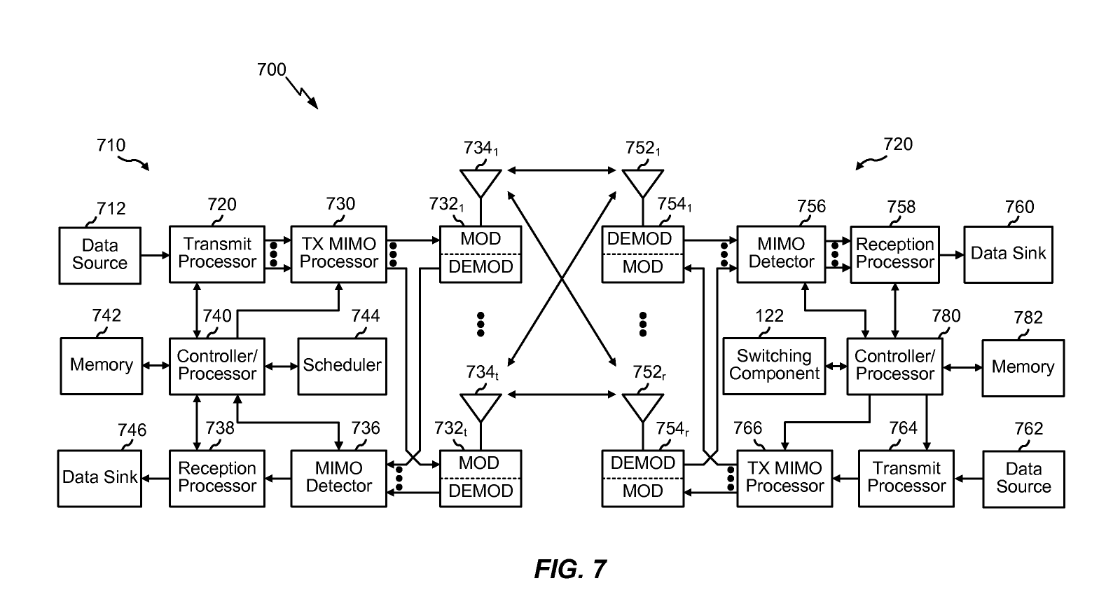

FIG. 7 is a block diagram conceptually illustrating an exemplary eNodeB 710 and an exemplary UE 720 configured in accordance with an aspect of the present disclosure. For example, the base station/eNodeB 710 and the UE 720, as shown in FIG. 7, may be one of the base stations/eNodeBs and one of the UEs in FIG. 1, for example, UE 120 including a switching component 122. The base station 710 may be equipped with antennas 734₁₋ₜ, and the UE 720 may be equipped with antennas 752₁₋ᵣ, wherein t and r are integers greater than or equal to one.

At the base station 710, a base station transmit processor 720 may receive data from a base station data source 712 and control information from a base station controller/processor 740. The control information may be carried on the PBCH, PCFICH, PHICH, PDCCH, etc. The data may be carried on the PDSCH, etc. The base station transmit processor 720 may process (e.g., encode and symbol map) the data and control information to obtain data symbols and control symbols, respectively. The base station transmit processor 720 may also generate reference symbols, e.g., for the PSS, SSS, and cell-specific reference signal (RS). A base station transmit (TX) multiple-input multiple-output (MIMO) processor 730 may perform spatial processing (e.g., precoding) on the data symbols, the control symbols, and/or the reference symbols, if applicable, and may provide output symbol streams to the base station modulators/demodulators (MODs/DEMODs) 732₁₋ₜ. Each base station modulator/demodulator 732 may process a respective output symbol stream (e.g., for OFDM, etc.) to obtain an output sample stream. Each base station modulator/demodulator 732 may further process (e.g., convert to analog, amplify, filter, and upconvert) the output sample stream to obtain a downlink signal. Downlink signals from modulators/demodulators 732₁₋ₜ may be transmitted via the antennas 734₁₋ₜ, respectively.

At the UE 720, the UE antennas 752₁₋ᵣ may receive the downlink signals from the base station 710 and may provide received signals to the UE modulators/demodulators (MODs/DEMODs) 754₁₋ᵣ, respectively. Each UE modulator/demodulator 754 may condition (e.g., filter, amplify, downconvert, and digitize) a respective received signal to obtain input samples. Each UE modulator/demodulator 754 may further process the input samples (e.g., for OFDM, etc.) to obtain received symbols. A UE MIMO detector 756 may obtain received symbols from all the UE modulators/demodulators 754₁₋ᵣ, and perform MIMO detection on the received symbols if applicable, and provide detected symbols. A UE reception processor 758 may process (e.g., demodulate, deinterleave, and decode) the detected symbols, provide decoded data for the UE 720 to a UE data sink 760, and provide decoded control information to one or more UE controllers/processors 780. The switching component 122 may provide for switching a data path for a service between controllers/processors 780.

On the uplink, at the UE 720, a UE transmit processor 764 may receive and process data (e.g., for the PUSCH) from a UE data source 762 and control information (e.g., for the PUCCH) from the UE controller/processor 780. The switching component 122 may determine the UE controller/processor 780 for a service and switch the controller/processor while maintaining a connection for the service. The UE transmit processor 764 may also generate reference symbols for a reference signal. The symbols from the UE transmit processor 764 may be precoded by a UE TX MIMO processor 766 if applicable, further processed by the UE modulator/demodulators 754₁₋ᵣ (e.g., for SC-FDM, etc.), and transmitted to the base station 710. At the base station 710, the uplink signals from the UE 720 may be received by the base station antennas 734, processed by the base station modulators/demodulators 732, detected by a base station MIMO detector 736 if applicable, and further processed by a base station reception processor 738 to obtain decoded data and control information sent by the UE 720. The base station reception processor 738 may provide the decoded data to a base station data sink 746 and the decoded control information to the base station controller/processor 740.

The base station controller/processor 740 and the UE controller/processor 780 may direct the operation at the base station 710 and the UE 720, respectively. The base station controller/processor 740 and/or other processors and modules at the base station 710 may perform or direct, e.g., the execution of various processes for the techniques described herein. The UE controller/processor 780 and/or other processors and modules at the UE 720 may also perform or direct, e.g., the execution of the functional blocks illustrated in FIG. 2 and/or other processes for the techniques described herein. The base station memory 742 and the UE memory 782 may store data and program codes for the base station 710 and the UE 720, respectively. A scheduler 744 may schedule UEs 720 for data transmission on the downlink and/or uplink.

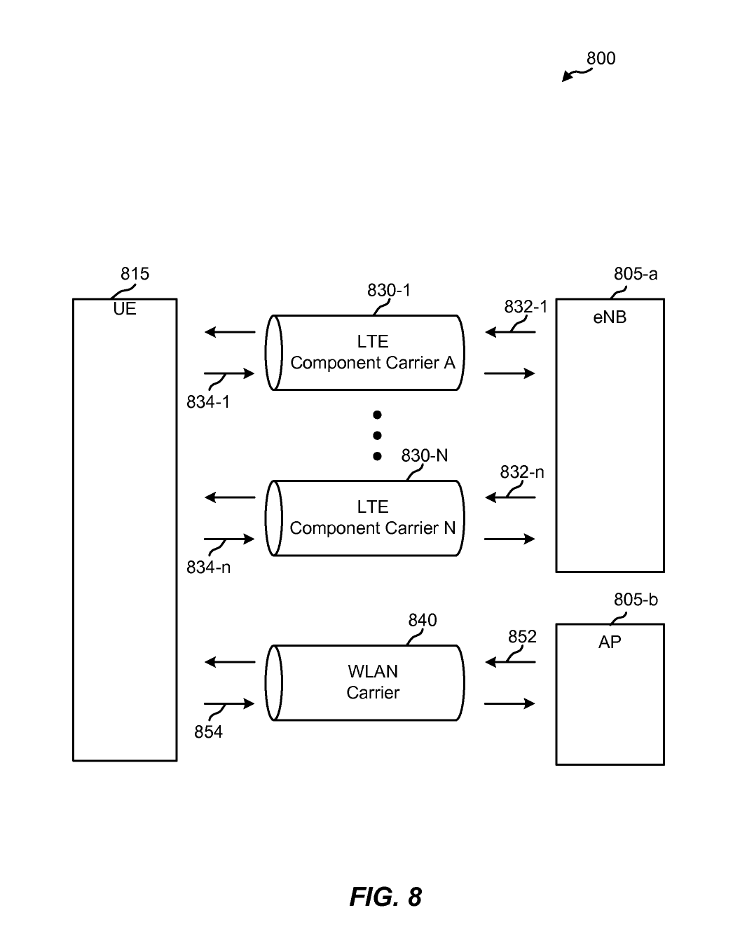

FIG. 8 illustrates a block diagram conceptually illustrating an aggregation of LTE and WLAN radio access technologies at a user equipment (UE), in accordance with an aspect of the present disclosure. The aggregation may occur in a system 800 including a multi-mode UE 815, which can communicate with an eNodeB 805-a using one or more component carriers 1 through N (CC₁-CC_{N}), and with a WLAN access point (AP) 805-b using WLAN carrier 840. The UE 815 may be an example of the UE 120 described above with reference to the previous Figures and having a switching component 122. The eNodeB 805-a may be an example of one or more of the eNodeBs or base stations 110 described above with reference to the previous Figures. While only one UE 815, one eNodeB 805-a, and one AP 805-b are illustrated in FIG. 8, it will be appreciated that the system 800 can include any number of UEs 815, eNodeBs 805-a, and/or APs 805-b.

The eNodeB 805-a can transmit information to the UE 815 over forward (downlink) channels 832-1 through 832-N on LTE component carriers CC₁ through CC_{N} 830. In addition, the UE 815 can transmit information to the eNodeB 805-a over reverse (uplink) channels 834-1 through 834-N on LTE component carriers CC₁ through CC_{N}. Similarly, the AP 805-b may transmit information to the UE 815 over forward (downlink) channel 852 on WLAN carrier 840. In addition, the UE 815 may transmit information to the AP 805-b over reverse (uplink) channel 854 of WLAN carrier 840.

In describing the various entities of FIG. 8, as well as other figures associated with some of the disclosed embodiments, for the purposes of explanation, the nomenclature associated with a 3GPP LTE or LTE-A wireless network is used. However, it is to be appreciated that the system 800 can operate in other networks such as, but not limited to, an OFDMA wireless network, a CDMA network, a 3GPP2 CDMA2000 network and the like.

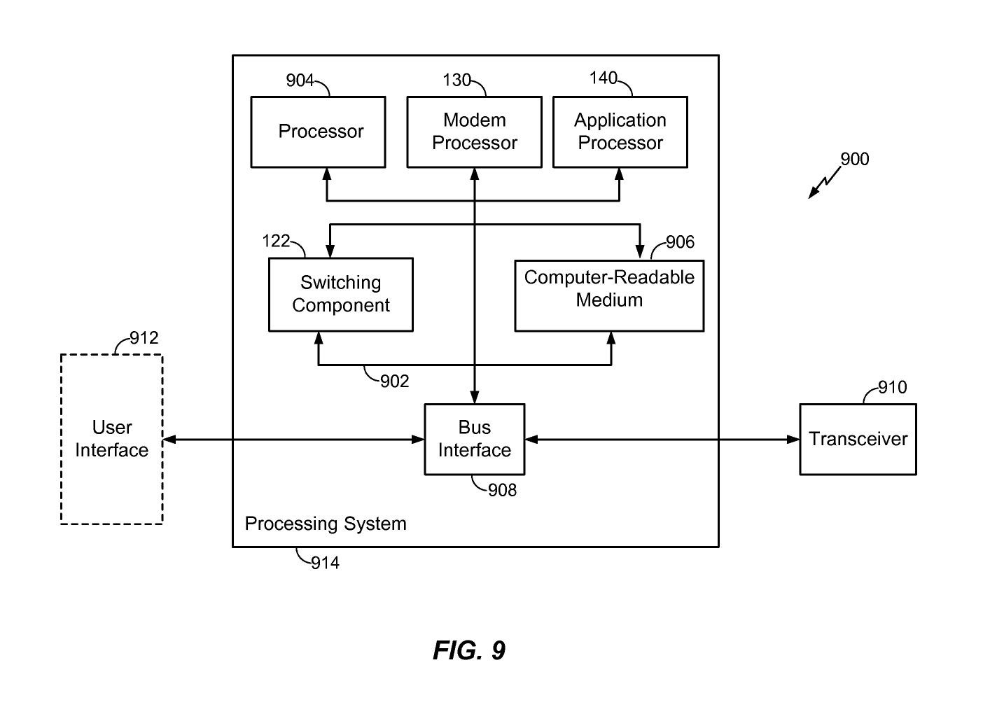

FIG. 9 is a block diagram illustrating an example of a hardware implementation for an apparatus 900 employing a processing system 914. The processing system 914 may include a switching component 122 for dynamically switching a data path between processors. In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors, represented by the general processor 904, the modem processor 130, and the application processor 140 and computer-readable media, represented generally by the computer-readable medium 906. The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium. Depending upon the nature of the apparatus, a user interface 912 (e.g., keypad, display, speaker, microphone, joystick) may also be provided.

The processor 904 may be responsible for managing the bus 902 and general processing, including the execution of software stored on the computer-readable medium 906. The software, when executed by the processor 904, causes the processing system 914 to perform the various functions described infra for any particular apparatus. The computer-readable medium 906 may also be used for storing data that is manipulated by the processor 904 when executing software. In an aspect, for example, at least a portion of the functions, operations, and/or methods performed by the switching component 122 may be implemented by the processor 904 in cooperation with the computer-readable medium 906.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for switching data paths in a wireless device having a first processor and a second processor, the method comprising:
determining a change to a service, the service using a first data path including a first internet protocol (IP) stack on the first processor and lower layer processing on a wireless modem, the first data path providing a tunneled connection to the service through a network;
establishing a second data path for the service, the second data path including a second IP stack on the second processor including tunneling to the service through the network and the lower layer processing on the wireless modem; and
switching from the first data path to the second data path in response to establishing the second data path.

2. The method of claim 1, wherein determining a change to a service comprises determining a transfer of the service from the first processor to the second processor.

3. The method of claim 1, further comprising placing the first processor in a power save mode responsive to switching the service from the first data path to the second data path.

4. The method of claim 1, further comprising releasing tunneling parameters for the service on the first data path in response to establishing the second data path.

5. The method of claim 1, wherein the tunneling includes an IPsec security association, wherein establishing the second data path on the second processor comprises performing an IPsec rekeying, installing a new security association on the second IP stack on the second processor, and deleting an old security association with the network on the first processor.

6. The method of claim 1, wherein the first processor is an application processor and the second processor is a modem processor.

7. The method of claim 6, further comprising obtaining, by the modem processor, a tunneling parameter from the network and installing the tunneling parameter on the IP stack of the modem processor and deleting the tunneling parameter on the IP stack of the application processor.

8. The method of claim 1, wherein the first processor is a modem processor and the second processor is an application processor.

9. The method of claim 8, further comprising obtaining, by the modem processor, a tunneling parameter from the network and installing the tunneling parameter on the IP stack of the application processor and deleting the tunneling parameter on the IP stack of the modem processor.

10. The method of claim 1, further comprising maintaining the tunneled connection to the service through the network while switching data paths.

11. The method of claim 1, wherein switching the data path comprises switching the data path without packet loss.

12. The method of claim 1, further comprising continuing to send and receive packets on the first data path while establishing the second data path.

13. The method of claim 1, wherein determining a change to the service comprises determining that a video component to be processed by the second processor has been added to a voice call processed by the first processor.

14. The method of claim 1, wherein determining a change to the service comprises determining that a video component processed by the first processor has been removed from a video call processed by the first processor.

15. The method of claim 1, wherein the wireless modem is a wireless local area network (WLAN) modem.

16. The method of claim 1, wherein the wireless modem is a wireless wide area network (WWAN) modem configured to connect to the service on a core network through the network.

17. An apparatus for switching data paths of a service, said apparatus comprising:
first means for processing;
second means for processing;
means for determining a change to a service, the service using a first data path including a first internet protocol (IP) stack on the means for processing and lower layer processing on a wireless modem, the first data path providing a tunneled connection to the service through a network;
means for establishing a second data path for the service, the second data path including a second IP stack on the second means for processing including tunneling to the service through the network and the lower layer processing on the WLAN modem; and
means for switching from the first data path to the second data path in response to establishing the second data path.

18. The apparatus of claim 17, further comprising means for placing the first processor in a power save mode responsive to switching the service from the first data path to the second data path.

19. The apparatus of claim 17, wherein the tunneling includes an IPsec security association, wherein the means for establishing the second data path on the second processor is configured to perform an IPsec rekeying and install a new security association on the second IP stack on the second processor.

20. A computer-readable medium storing computer executable code, comprising:
code for causing a computer to determine a change to a service, the service using a first data path including a first internet protocol (IP) stack on the first processor and lower layer processing on a wireless modem, the first data path providing a tunneled connection to the service through a network;
code for causing a computer to establish a second data path for the service, the second data path including a second IP stack on the second processor including tunneling to the service through the network and the lower layer processing on the wireless modem; and
code for causing a computer to switch from the first data path to the second data path in response to establishing the second data path.

21. The computer-readable medium of claim 20, further comprising code for placing the first processor in a power save mode responsive to switching the service from the first data path to the second data path.

22. The computer-readable medium of claim 20, wherein the tunneling includes an IPsec security association, wherein code for causing a computer to establish the second data path on the second processor is configured to perform an IPsec rekeying and install a new security association on the second IP stack on the second processor.

23. A wireless communication device for switching data paths of a service, comprising:
a first processor;
a second processor;
a wireless modem connected to the first processor and the second processor;
a service component configured to determine a change to a service, the service using a first data path including a first internet protocol (IP) stack on the first processor and lower layer processing on the wireless modem, the first data path providing a connection to the service through a network;
a tunneling component configured to establish a second data path for the service, the second data path including a second IP stack on the second processor including tunneling to the service through the network and the lower layer processing on the wireless modem; and
a switching component configured to switch from the first data path to the second data path in response to establishing the second data path.

24. The wireless communication device of claim 23, wherein determining a change to a service comprises determining a transfer of the service from the first processor to the second processor.

25. The wireless communication device of claim 23, further comprising a power controller configured to place the first processor in a power save mode responsive to switching the service from the first data path to the second data path.

26. The wireless communication device of claim 23, wherein the tunneling component is configured to release a tunneling parameter for the service on the first data path in response to establishing the second data path.

27. The wireless communication device of claim 23, wherein the tunneling includes an IPsec security association, wherein the tunneling component is configured to perform an IPsec rekeying and install a new security assocation on the second processor.

28. The wireless communication device of claim 23, wherein the first processor is an application processor and the second processor is a modem processor.

29. The wireless communication device of claim 23, wherein the first processor is a modem processor and the second processor is an application processor.

30. The wireless communication device of claim 29, wherein the modem processor is configured to obtain a tunneling parameter from the network and install the tunneling parameter on the IP stack of the application processor.

31. The wireless communication device of claim 23, wherein the switching component is configured to maintain the tunneled connection to the service through the network while switching data paths.

32. The wireless communication device of claim 23, wherein the switching component is configured to switch the data path without packet loss.

33. The wireless communication device of claim 23, wherein the wireless modem is a wireless local area network (WLAN) modem.
